(19) United States
(12) Patent Application Publication
(10) Pub. No.: US 2016/0065123 A1
(43) Pub. Date: Mar. 3, 2016

(54) METHOD OF OPERATING A PHOTOVOLTAIC MODULE ARRAY

(71) Applicant: First Solar, Inc., Perrysburg, OH (US)

(72) Inventors: William Hayes, Perrysburg, OH (US); Alex Panchula, Perrysburg, OH (US)

(21) Appl. No.: 14/468,609

(22) Filed: Aug. 26, 2014

(51) Int. Cl. H02S 40/10; H02S 20/30

(52) U.S. Cl. CPC H02S 40/10; H02S 20/30

(57) ABSTRACT

A method for operating a photovoltaic module array includes identifying when an atmospheric temperature drops below a dew point. A photovoltaic module is then positioned such that a module face is oriented at a first position substantially parallel to a ground surface permitting dew to form on the module face, the dew mixing with dust present on the module face. An angular orientation of the photovoltaic module is changed after dew formation so the module face is oriented at a second position angled away from the first position facilitating the removal of the dew entrained with the dust to be removed from the module face, thereby cleaning the module face.

### FIELD

The present disclosure relates to solar module arrays and more specifically to devices and methods for operating photovoltaic module arrays to minimize soil and dust accumulation on the photovoltaic modules thereof.

### BACKGROUND

Solar energy produced by the sun can be captured by photovoltaic (PV) modules. Mounting systems for PV modules can be fixed or can track the sun's diurnal motion. Typical single axis tracking systems include one or more torque tubes which are connected to and are capable of rotating a group of PV modules with respect to a longitudinal axis of the torque tubes. The torque tubes are supported on multiple support posts or piles such as driven posts, drilled concrete piles or ballasted foundations. The torque tubes support one or more PV module support structures collectively defining a solar module tracker. PV module power plants typically have hundreds or thousands of solar module trackers with multiple rows of PV modules, each rotated to track the sun's diurnal motion.

The orientation of each PV module and of the solar module array in general with respect to the sun during daylight conditions can be controlled by an electric motor which is connected to and rotates the torque tube connected to the PV modules. An actuator arm mount translates axial and rotational displacement of a drive shaft connected to the electric motor to the rotational motion necessary for rotation of the solar module tracker.

A glass layer is typically the top or outer-most layer in a photovoltaic module and is formed from a high band gap material to allow transmittance of sunlight to underlying layers of the device. The glass layer is exposed to atmosphere and can become coated with dust, dirt, sand, and the like during use, collectively referred to hereinafter as “dust”. As dust develops and thickens, transmittance of sunlight through the glass layer to the underlying layers may be diminished, thereby affecting a performance of a PV module. Methods to clean PV module glass layers have therefore been developed that include water washing systems, powered cleaning systems, and robotic cleaning systems. Such systems have substantial hardware costs, require additional power to operate, and if water is used require a substantial source of water. Alternate, less power intensive systems and less costly modules are therefore desirable.

### SUMMARY

This section provides a general summary of the disclosure, and is not a comprehensive disclosure of its full scope or all of its features.

According to one aspect of the present disclosure a method for operating a photovoltaic module array includes identifying when an atmospheric temperature drops below a dew point. A photovoltaic module is then rotated such that a module face is oriented at a first position to permit dew to form on the module face.

According to another aspect, a method for operating a photovoltaic module array includes identifying when an atmospheric temperature drops below a dew point. A photovoltaic module is then rotated such that a module face is oriented at a first position substantially parallel to a ground surface permitting dew to form on the module face, the dew mixing with dust present on the module face. An angular orientation of the photovoltaic module is changed after dew formation so the module face is oriented at a second position angled away from the first position permitting the dew together with the dust to be removed from the module face.

According to a further aspect, a method for operating a photovoltaic module array includes identifying when an atmospheric moisture is present above a predetermined threshold. A photovoltaic module is then positioned such that a module face is oriented at a first position substantially parallel to a ground surface permitting the atmospheric moisture to accumulate on the module face, the atmospheric moisture mixing with dust present on the module face. An angular orientation of the photovoltaic module is changed after collection of the atmospheric moisture so the module face is oriented at a second position angled away from the first position permitting the atmospheric moisture together with the dust to be removed from module face.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top left perspective view of a solar module tracker;

FIG. 2 is a bottom right perspective view of the solar module tracker of FIG. 1; and

FIG. 3 is an end elevational view of the solar module tracker of FIG. 1.

Corresponding reference numerals indicate corresponding parts throughout the several views of the drawings.

### DETAILED DESCRIPTION

Example embodiments will now be described more fully with reference to the accompanying drawings.

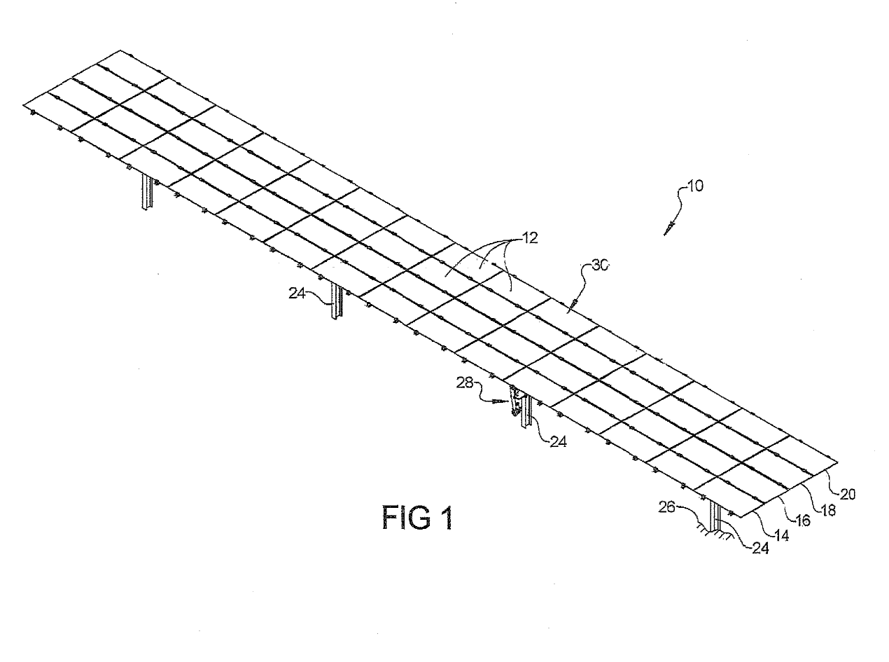

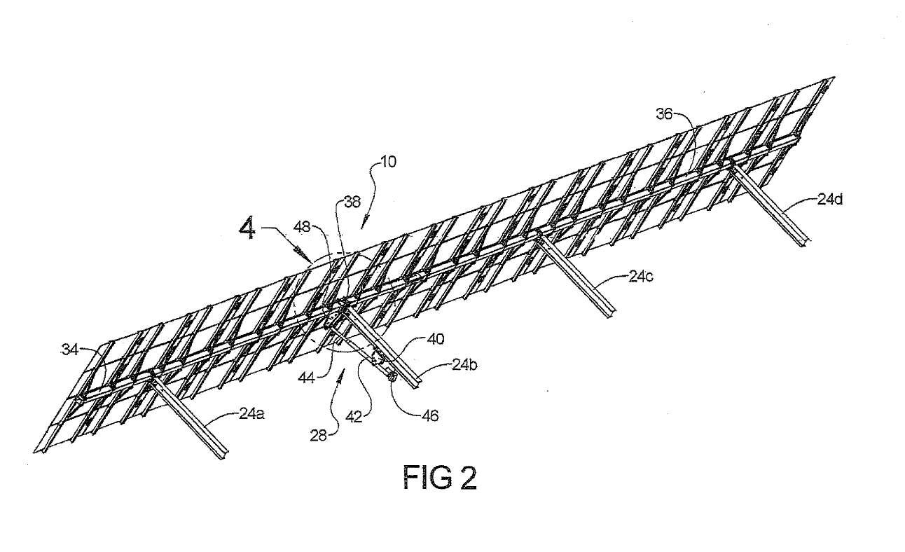

Referring to FIG. 1, a solar module array 10 commonly includes multiple solar modules 12. Multiple, including up to hundreds of solar module trackers 10 are combined to create a solar module field. The solar modules 12 are commonly grouped in rows or modules of two, four, or six. In the exemplary embodiment of FIGS. 1-2, the solar module array10 includes first, second, third, and fourth photovoltaic (PV) modules 14, 16, 18, 20. The quantity of solar module tracker PV modules is not limiting to this disclosure.

Each of the first, second, third and fourth PV modules 14, 16, 18, 20 have a common width and successive ones of the PV modules are separated by a common width module gap. Moisture collecting on any of the PV modules can therefore be removed therefrom through each module gap. Multiple array posts or piles 24 are provided to support each solar module array 10 at a similar height above a ground surface 26 which allows for rotation of the PV modules. It is understood that the posts may be staggered to place the module trackers 10 at different heights, as desired. Each solar module array 10 includes a tracker orientation control assembly 28 connected to structure of one of the support piles 24 which is automatically operated to change an orientation angle of the individual solar module array 10 with respect to the ground surface 26 to collectively direct a module face 30 of each solar module 12 toward the sun as a position of the sun with respect to the solar module array 10 changes over time. Each PV module can be rotated over a range of approximately 90 degrees, which includes a “flat” position wherein its module face 30 is oriented horizontal or substantially parallel to the ground surface 26.

With specific reference to FIG. 2, each of the solar module arrays 10 are supported on and rotated with respect to at least one and according to several aspects elongated, axially aligned and co-rotated first and second torque tubes 34, 36 which each support half of the first, second, third and fourth PV modules 14, 16, 18, 20. One of the first or second torque tubes 34, 36, in this example first torque tube 34, is directly rotatably connected to an inner one of the piles 24 shown as first, second, third and fourth piles 24a, 24b, 24c, 24d, such as second pile 24b shown. A bearing assembly 38 may be connected to the first support tube 34 and to the second pile 24b to permit axial rotation of first support tube 34. The first and second torque tubes 34, 36 thereby define the axis of rotation of the single axis tracker system.

The tracker orientation control assembly 28 can include a mount member 40 fixed to second pile 24b and an actuator arm 42 having an extendable and retractable shaft 44. The shaft 44 extends with respect to actuator arm 42 by operation of a motor 46. Positioned at an opposite end of the actuator arm 42 with respect to motor 46 is a pair of side plates defining plate assembly 48. The plate assembly 48 connects the actuator arm 42 and the shaft 44 to the first torque tube 34, such that extension or retraction of the shaft 44 rotates the plate assembly 48 and thereby axially rotates the first and second torque tubes 34, 36.

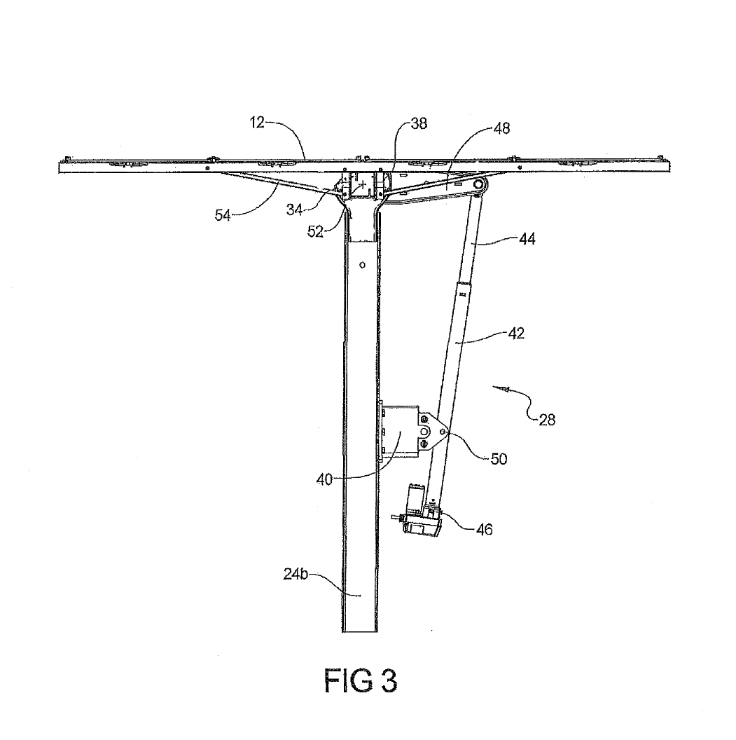

Referring to FIG. 3 and again to FIGS. 1-2, the PV module is shown rotated to the “flat” position wherein its module face 30 is oriented horizontal or substantially parallel to the ground surface 26. To rotate the PV module, the actuator arm 42 is rotatably connected by a pin 50 to the mount member 40 to allow the actuator arm 42 as well as the plate assembly 48 to rotate during extension or retraction of the shaft 44, Rotation of the plate assembly 48 axially rotates the first torque tube 34 and the second torque tube 36. The first and second torque tubes 34, 36 together rotate with respect to a longitudinal axis 52 which defines the axis of rotation of a PV module. Also connected to the first and second torque tubes 34, 36 are multiple support frames 54 which extend outwardly to provide support for the individual solar modules 12.

Operation of the motor 46 can be automatically controlled by a computer which is programmed with data stored in a memory, or the motor 46 and/or the computer may be manually manipulated by an operator. Programming can include data from solar location tables that periodically, for example once every 5 minutes, is used to operate motor 46 to rotate the first and second torque tubes 34, 36 and thereby move the PV modules to a predetermined position based on a known position of the sun to maximize exposure of the PV modules to incident solar radiation.

The first and the second torque tubes 34, 36 are rotated during daylight hours by a program that uses a predetermined, known position of the sun on a daily, monthly, and annual basis to maximize direct alignment of the module faces 30 with the sun during diurnal travel of the sun. The module faces 30 can be rotated about a total arc ranging between approximately 90 to 120 degrees with respect to the longitudinal axis 52 by operation of the motor 46. The total arc of rotation is not limiting, and can be more or less than 90 to 120 degrees based on conditions at each solar array. Starting from the position defined as the “flat” position of the module faces 30, which is oriented approximately parallel to the ground surface 26, the module faces 30 can be rotated in a range of approximately 45 to 60 degrees counterclockwise with respect to the longitudinal axis 52 away from the “flat” position, to a position rotated in a range of approximately 45 to 60 degrees clockwise about the longitudinal axis 52 away from the “flat” position. The rotation angle having a range of up to approximately 60 degrees is exemplary and is not limiting to this disclosure as the rotation angle or a maximum storage angle can be predetermined at each solar array site.

To minimize collection of dust on module faces 30, the module faces can be rotated to one of the 45 to 60 degree rotated positions defining a “storage angle” during non-power operating conditions and during nighttime hours. It has been surprisingly identified that during nighttime conditions favoring formation of dew, when the ambient air temperature falls below the dew point, if the module faces 30 are positioned at the “flat” position in lieu of either of the 45 to 60 degree rotated or storage angle positions, dew will collect on the module faces 30. At or approximately at the time of sunrise, subsequent rotation of the module faces 30 toward one of the 45 to 60 degree rotated positions to initiate power generation from the PV module will cause dew runoff from module faces 30 by gravity force acting on the dew droplets. This dew runoff will also entrain dust that has collected on the module faces 30 and thereby self-clean the module faces 30 without the need for manual or machine cleaning system use, or the addition of water from a separate water source.

Maximum or optimum dew formation occurs at night, normally just before dawn, with clear atmospheric conditions. It is therefore desirable to track when such optimum dew formation conditions are present and to automatically signal the module faces 30 to move to the “flat” position instead of the normally stowed 45 to 60 degree position. Weather condition tracking algorithms can be used to identify when the optimum conditions are present for dew formation.

“Intelligent Idle” refers to an implementation of advanced control algorithms that promote additional energy generation for photovoltaic arrays with tracker systems. The control algorithms act upon the tracker actuators as a way to control the variable tilt angles during times of non-operation in order to minimize the amount of soil/dust and other contaminants that accumulates on the PV modules. At least three distinct methods can be applied to minimize soil/dust impact on system energy generation.

The first method is to minimize the rate at which soil/dust deposits on the PV modules. As described above, the first method is normally used by rotating the module faces 30 to one of the 45 to 60 degree rotated positions. The 45 to 60 degree rotated or maximum storage angle positions minimize the amount of soil/dust and other contaminants that accumulate on the PV modules.

According to one implementation of the first method, an algorithm is implemented that requires historical, real-time, and/or forecasted weather data input to control tracker tilt angles that will minimize accumulation of soil and other contaminants on PV modules. The weather data can be collected through stand-alone meteorological equipment in communication with the arrays 10 or integrated meteorological equipment.

According to a second implementation of the first method, predefined PV tracker angles as a function of time are used that minimize the amount of dust and other contaminants that deposit on PV modules. Each predefined PV tracker angle can be a function of a season and/or dependent on local environmental conditions, such as wind speed or wind direction.

The second method capitalizes upon the formation of dew on PV modules and uses dew droplets as a cleaning mechanism for the PV modules. According to a first implementation of the second method, predefined tracker angles as a function of time are used that promote the formation of dew on PV modules which will serve as a cleaning agent.

According to a second implementation of the second method, an algorithm that requires historical, real-time and/or forecasted weather data input is used in order to control tracker tilt angles that will promote the formation of dew on PV modules which will serve as a cleaning agent.

The third method is to use naturally occurring rainfall and other precipitation to help clean the PV modules. At least from about 3 mm to about 5 mm of water from rainfall is sufficient to clean dust from the module faces 30. According to one implementation of the third method, real-time or forecasted precipitation events are used to determine if sufficient rainfall is either forecasted, or is present, and to subsequently move the tracker to a predefined angle to maximize cleaning from actual rainfall. It is anticipated that maximum module face cleaning from naturally occurring rainfall will occur approximately at one of the 45 to 60 degree rotated positions, however, an angle less than 45 degrees may be optimum depending on the precipitation event, i.e., using factors such as actual wind direction and speed, actual rainfall amount over a predetermined time, and a total duration of the rainfall. For example, a shorter duration rainfall event having a reduced expected total rainfall amount may provide maximum cleaning potential at an angle between 45 degrees and the “flat” position. The algorithms can also be modified as the volumes of historical rainfall and cleaning effectiveness data increase from each solar array site.

According to several aspects of the present disclosure, a method for operating a photovoltaic module array includes: 1) identifying when an atmospheric temperature drops below a dew point; and 2) positioning, for example by rotating a photovoltaic module such that a module face is oriented at a first position to permit dew to collect on the module face. The method can further include changing an angular orientation of the photovoltaic module after dew collection so the module face is oriented at a second position permitting the dew together with dust present on the module face to be removed from the module face. The method can further include performing the changing step after sunrise. The method can further include providing the first position substantially parallel to a ground surface.

The method can further include providing the second position having the module face oriented substantially at a 45 to 60 degree angle with respect to the first position. The method can further include collecting real-time atmospheric data and applying an algorithm to the data to perform the identifying step. The method can further include performing the identifying and positioning steps at night when the photovoltaic module array is not generating electrical power. The identifying and positioning steps can also be performed during any time of the day or night when the photovoltaic module array is not generating electrical power. The method can further include holding the photovoltaic module at the first position until dew is visually present on the module face in a droplet size.

Because from at least about 3 mm to about 5 mm of water contacting the module face 30 has been found to effectively provide sufficient water during a rainfall event to clean the module face, the PV module can be rotated to the first or to the “flat” position in anticipation of a predicted rainfall of at least from about 3 mm to about 5 mm or when rainfall is occurring. The PV module can thereafter be moved or angularly rotated to the second or angular (approximately 45 to 60 degree rotated) position at any time after visual or measured confirmation that from about 3 mm to about 5 mm of water as rain has fallen, or if meteorological data is being collected, at any time after a predicted or measured amount of rainfall occurs of 3 mm to 5 mm column height.

For each of the above operating methods, an actual soil or dust level on the module face 30 effects power level production. This indication is used to determine the algorithm used to position the PV module at the flat or a rotated position to attain maximum cleaning benefit. The actual dust level can be determined by in-situ viewing or remote camera viewing, indirectly by its impact on power level, or by a measurement system. The algorithm used can further define a time spent at any PV module orientation position that optimizes cleaning. Different soiling conditions which may occur at different times of the year or at solar array locations in different parts of the world may also require more or less frequent operation of the self-cleaning method of the present disclosure. For example the self-cleaning method may be used 1 to 2 times per week versus 1 to 2 times per month.

A threshold condition can also be included in the algorithm which triggers a cleaning operation such that the method for operating a photovoltaic module array of the present disclosure is initiated only at a predetermined amount of dust level or power drop-off. For example, if a panel face is determined to be below the predetermined “clean” condition of operation, a cleaning event can be initiated at the next available time that the atmospheric conditions support dew formation.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for operating a photovoltaic module array, comprising:
identifying when an atmospheric temperature drops below a dew point; and
rotating a photovoltaic module such that a module face is oriented at a first position to permit dew to collect on the module face.

2. The method for operating a photovoltaic module array of claim 1, further including changing an angular orientation of the photovoltaic module after dew collection so the module face is oriented at a second position to facilitate the removal of dew entrained with dust be removed from module face.

3. The method for operating a photovoltaic module array of claim 2, further including performing the changing step after sunrise.

4. The method for operating a photovoltaic module array of claim 2, wherein the first position is substantially parallel to a ground surface.

5. The method for operating a photovoltaic module array of claim 4, wherein the second position is oriented up to about a 60 degree angle with respect to the first position.

6. The method for operating a photovoltaic module array of claim 1, further including:
collecting real-time atmospheric data and applying an algorithm to the data to perform the identifying step; and
selecting the algorithm from a plurality of algorithms individually including predetermined dust level on the module face.

7. The method for operating a photovoltaic module array of claim 1, further including performing the identifying and rotating steps at night when the photovoltaic module array is not generating electrical power.

8. The method for operating a photovoltaic module array of claim 1, further including performing the identifying and rotating steps during any time of the day or night when the photovoltaic module array is not generating electrical power.

9. The method for operating a photovoltaic module array of claim 1, further including holding the photovoltaic module at the first position until visible dew droplets are visually present on the module face.

10. A method for operating a photovoltaic module array, comprising:
identifying when an atmospheric temperature drops below a dew point;
rotating a photovoltaic module such that a module face is oriented at a first position substantially parallel to a ground surface permitting dew to form on the module face, the dew mixing with dust present on the module face; and
changing an angular orientation of the photovoltaic module after dew formation so the module face is oriented at a second position angled away from the first position facilitating the removal of dew entrained with the dust to be removed from module face.

11. The method for operating a photovoltaic module array of claim 10, further including collecting atmospheric temperature measurements in real-time for use in the identifying step.

12. The method for operating a photovoltaic module array of claim 10, further including applying predicted atmospheric temperature conditions for use in the identifying step.

13. The method for operating a photovoltaic module array of claim 10, further including:
determining an optimum orientation angle of the photovoltaic module to maximize cleaning of the module by the removal of dew entrained with dust therefrom; and
applying an algorithm to vary the orientation angle of the photovoltaic module to achieve an optimum accumulation of dew thereon thereby optimizing the cleaning of the module face when the dew entrained with dust is removed therefrom.

14. The method for operating a photovoltaic module array of claim 10, further including moving the photovoltaic module to the second position during non-power generating conditions to minimize buildup of dust on the module face when the atmospheric temperature is above the dew point.

15. A method for operating a photovoltaic module array, comprising:
identifying when an atmospheric moisture is present above a predetermined threshold;
moving a photovoltaic module such that a module face is oriented at a first position substantially parallel to a ground surface permitting the atmospheric moisture to accumulate on the module face, the atmospheric moisture mixing with dust present on the module face; and
changing an angular orientation of the photovoltaic module after collection of the atmospheric moisture so the module face is oriented at a second position angled away from the first position facilitating the removal of the atmospheric moisture entrained the dust from the module face.

16. The method for operating a photovoltaic module array of claim 15, further including identifying when an atmospheric temperature drops below a dew point to initiate the identifying step.

17. The method for operating a photovoltaic module array of claim 16, further including retaining the photovoltaic module with the module face oriented at the first position during an entire period of time that the atmospheric temperature is below the dew point thereby permitting dew to form on the module face and prior to conducting the changing step.

18. The method for operating a photovoltaic module array of claim 15, further including retaining the photovoltaic module such that the module face is oriented at the first position until from about 3 mm to about 5 mm of the atmospheric moisture has contacted the module face prior to conducting the changing step.

19. The method for operating a photovoltaic module array of claim 15, further including applying predicted atmospheric temperature conditions for use in the identifying step.

20. The method for operating a photovoltaic module array of claim 15, further including:
determining an optimum orientation angle of the photovoltaic module to maximize cleaning due to atmospheric moisture and dust drain off; and
applying an algorithm to vary the orientation angle of the photovoltaic module to achieve optimum drain and cleaning of the module face.
